(19) United States
(12) Patent Application Publication
(10) Pub. No.: US 2006/0109131 A1
(43) Pub. Date: May 25, 2006

(54) Managing hidden objects using RFID technology

(76) Inventors: Prosenjit Sen, Fremont, CA (US); Dipankar Sen, Mountain View, CA (US)

Correspondence Address: PERKINS COIE LLP, P.O. BOX 2168, MENLO PARK, CA, 94026, US

(21) Appl. No.: 11/150,863

(22) Filed: Jun. 10, 2005

Related U.S. Application Data
(60) Provisional application No. 60/630,835, filed on Nov. 23, 2004.

(51) Int. Cl. G08B 13/14; G01S 13/08; G06Q 30/00; G06K 19/06; G08B 1/08; G08B 5/22; G01V 3/08

(52) U.S. Cl. 340/572.8; 235/385; 235/492; 342/126; 340/539.13; 340/825.49; 324/326

(57) ABSTRACT

The present invention teaches a variety of mechanisms, techniques and systems for managing, labeling, detecting, locating, and utilizing Hidden Objects utilizing RFID technology, handheld data processing units, and a centralized server computer maintaining a database of information related to a plurality of Hidden Objects. The teaching of the present invention has application across a wide variety of industries including constructions, utility, governmental, military, waste water management, etc.

### CROSS REFERENCE TO RELATED APPLICATION

This application claims priority to U.S. Provisional Patent Application No. 60/630,835, entitled, “Detecting, Locating and Managing Hidden Objects Using RFID Technology, and which is hereby incorporated by reference in its entirety.

### FIELD OF INVENTION

The present invention relates generally to the field of detecting and locating hidden objects or assets located underground, above the ground or concealed in walls or other structures. More specifically, the present invention teaches a variety of systems and methods utilizing radio frequency identification (RFID) technology for labeling, detecting, mapping, locating, tracking, maintaining, and managing hidden assets of any type.

### DESCRIPTION OF PRIOR ART

Electrical, telecommunciations (fiber-optic and copper), oil, gas, water supply (drinking and industrial water), wastewater, chemical, air conditioning and other utility lines or pipes, PINS used as location identifiers for surveying and more are often placed under the ground or in between the walls of erected structures. They may also be above the ground but over time become hidden because of vegetation or other such covering. This covering is often for ergonomic, safety and cost reasons. In addition to lines and pipes, storage tanks and vessels are also kept under the ground. Also wooden beams and other such structures are often placed between the walls in houses and other erected structures. All these are referred to as “Hidden Objects.”

The use of Hidden Objects occurs in a wide variety of industries including utility companies, manufacturing plants and facilities, government, construction industry, hospitals, airports, gas stations, private and commercial properties, real-estate industry, research labs, universities, cities, municipalities, oil and gas industry and more. All these are collectively referred to as “User Companies.”

It is important to know the exact location of the Hidden Objects when repair and additions are made to industrial and urban structures, or whenever activity is occurring around such Hidden Objects. Unfortunately, time and again, the exact location of these objects deviate from “as-built” drawings, if the latter exists, design drawings and other mechanisms used to collect location data. As a result, when repair services or additions to facilities require construction in the vicinity of these lines, the construction runs into unanticipated problems such as breakage, re-routing, and delays. In order to perform cost effective detection of such underground objects and objects concealed in and around erected structures and potential construction sites, it is essential that the presence, location and depth of such lines be accurately determined. Locating these Hidden Object using available techniques is costly and ineffective.

Existing techniques for detecting underground assets include the use of technologies such as GPR (ground penetrating radar). However, GPR based systems generate large amounts of unnecessary data, data that is non-specific or non-descriptive of the location and line identified, and therefore results in inaccuracies and a lower level of specifiable detail about the object. GPR tends to be unable to distinguish between the signals returned by an underground object of interest from that of the signals returned by other sub-surface objects.

GPS is also used to locate assets. In this case, existing maps are digitized and the data is stored in a database. This data is accessed using a GPS enabled handheld device on the field to locate the assets. However, the problems with this approach are many. The accuracy of most GPS devices is 3 to 5 m unless Differential GPS (DGPS) is used which requires extensive processing time and is expensive. Given this margin of error, locations identified with GPS also lack in repeatability. Additionally, GPS requires line of sight with satellites and does not function properly in shades of trees, buildings etc.

Sometimes metal detectors are used in addition to GPS to locate Hidden Objects. Metal detectors have problems such as failing to distinguish between a metallic utility line and another piece of metal that is adjacent to it.

What is needed is an accurate, cost efficient system and method for labeling, detecting, mapping, locating, tracking, maintaining, monitoring, protecting and managing the Hidden Objects.

### BRIEF DESCRIPTION OF DRAWINGS

FIG. 1 diagrammatically illustrates an RFID based location identifier (RFIDLI).

FIG. 2 shows two RFID based Location Identifiers and an underground utility line (Hidden Object) in a plot of open land.

FIG. 2a shows a plot of open land that has an underground utility line and RFIDLIs that are placed on the surface, directly above the utility line to label and track (or locate) the utility line.

FIG. 2b shows a cross section of the plot of land shown in FIG. 2a indicating that the RFIDLI is directly above the utility line and above the ground.

FIG. 2c shows an underground utility line and 4 RFIDLIs in an open plot of land. The RFIDLIs are placed in the vicinity of the underground line, but not directly above it.

FIG. 3 shows Hidden Objects in a wall.

FIG. 4 shows a horizontal area that could be a plot of land or other horizontal structure (e.g., cemented floor) with 3 Hidden Objects.

FIG. 5 represents an RFID Reference Tree showing the relationships between the Root Node RFIDLI, Intermediate Node RFIDLIs and Starting RFIDLIs.

FIG. 6 a system according to one embodiment of the invention.

### SUMMARY OF THE INVENTION

The present invention includes teachings directed to the identification of Hidden Objects using an integrated hardware and software system that uses RFID technology. According to one embodiment, RFID based Location Identifiers are placed in the vicinity of a Hidden Object. “In the vicinity” of a Hidden Object means on the Hidden Object, directly above the Hidden Object, on the surface of the Hidden Object, adjacent to the Hidden Object, etc. The data stored in the RFID tags of these RFIDLIs is read using a Handheld Data Processing Unit (HDPU) and is processed further to identify and determine location information for the Hidden Object, such as the co-ordinates, depth below the surface of the ground or depth from the surface and width at different points or locations of the Hidden Object.

This invention also teaches the development of a Location Based Master Database identified through RFIDLIs for different User Companies including the information on the Hidden Objects, location data of the Hidden Object and make, parts, installation/repair information, maintenance history and more, by locations. The data for different User Companies may be shared by each User Company with partners, customers and more

This invention is also directed to using the information accessed from the database, using the RFIDLIs as reference points, for maintenance purposes. This will allow a User Company to develop a maintenance history database to perform efficient maintenance.

### DETAILED DESCRIPTION OF EMBODIMENTS

The present invention teaches a variety of techniques and mechanisms that enable labeling, tracking, locating, maintaining, and managing Hidden Objects using an integrated hardware and software system that uses RFID technology.

The use of RFID based location identifiers (RFIDLI) as reference markers for storing critical information regarding the Hidden Objects is an attractive solution that can be used to accurately label, track, locate, maintain and manage the Hidden Objects. Certain embodiments of the present invention will save time and dollars during repairs and construction in industrial and urban facilities, and may also help crews locate the lines in the event that they want to make upgrades to existing facilities or add new facilities.

The invention will also help in monitoring and maintenance of a Hidden Object (and its contents) for better security and efficiency. In addition to the User Companies, this invention can also be extended to general surveys done by survey companies; demarcation of property boundaries, right of ways, etc; and as a general tool for homeowners to locate and delineate features that are important to them.

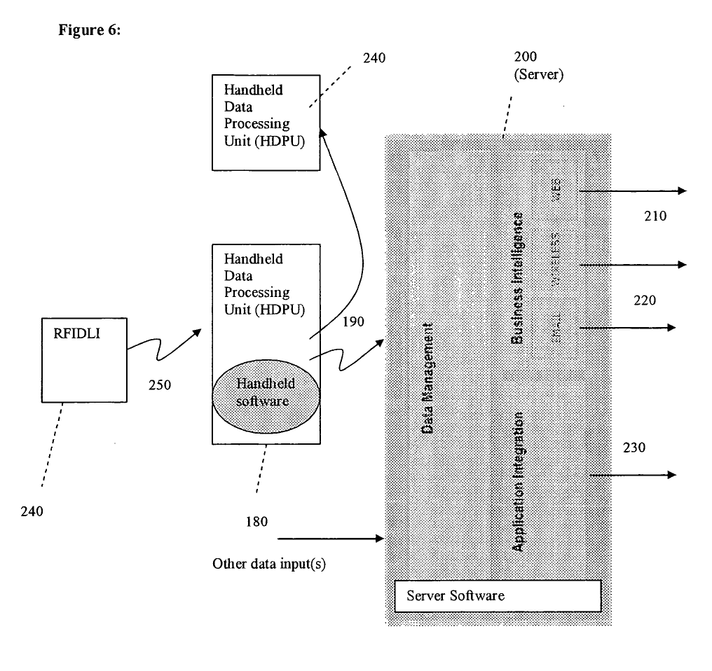

The present invention uses RFIDLI s, Handheld Data Processing Units (HDPU) and a Server (see FIG. 6). The HDPU unit runs the Handheld Software (h-sw) while the Server runs the Server Software (s-sw). As will be appreciated, the Server may comprise one or more computers and other computer hardware. The HDPU unit is comprised of an RFID Reader (or Readers) and a Handheld device (HD) such as a PocketPC, PDA or smart phone. If the HD does not have GPS receive capability, according to some embodiments the HDPU will include a GPS receiver. The Server, although of great use in certain embodiments, is not always necessary in every embodiment.

Data on the RFIDLIs and Hidden Objects may be stored on the Server (if it is used) and/or the HD. The HD communicates with the Server wirelessly in real-time or is synchronized to the Server (or via a PC, etc.). The discussion below assumes the use of a Server that communicates with the HD to send and receive data using a wireless connection. Those skilled in the art will readily recognize how a synchronized system or other model might operate given the teaching herein.

A Hidden Object's Location Data Set may be defined as the set of Location Data at multiple different Location Points along the layout of the Hidden Object. A Location Point is a point on the Hidden Object. Location Data can take the form of various suitable attributes such as X-Y co-ordinates, distance and angle (D, A), GPS coordinates (Latitude and Longitude, or Northing and Easting), elevation of ground at Hidden Object, Depth and Width of the Hidden Object at a particular Location Point and more. X-Y co-ordinates are relative co-ordinates (i.e., relative to a reference point X=0, Y=0).

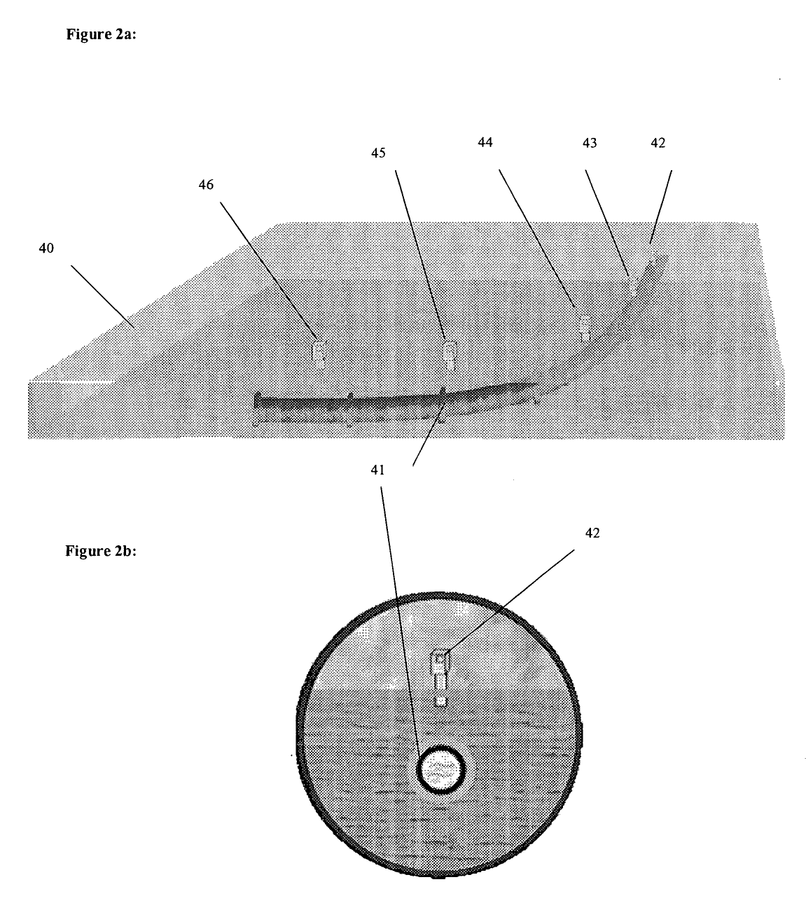

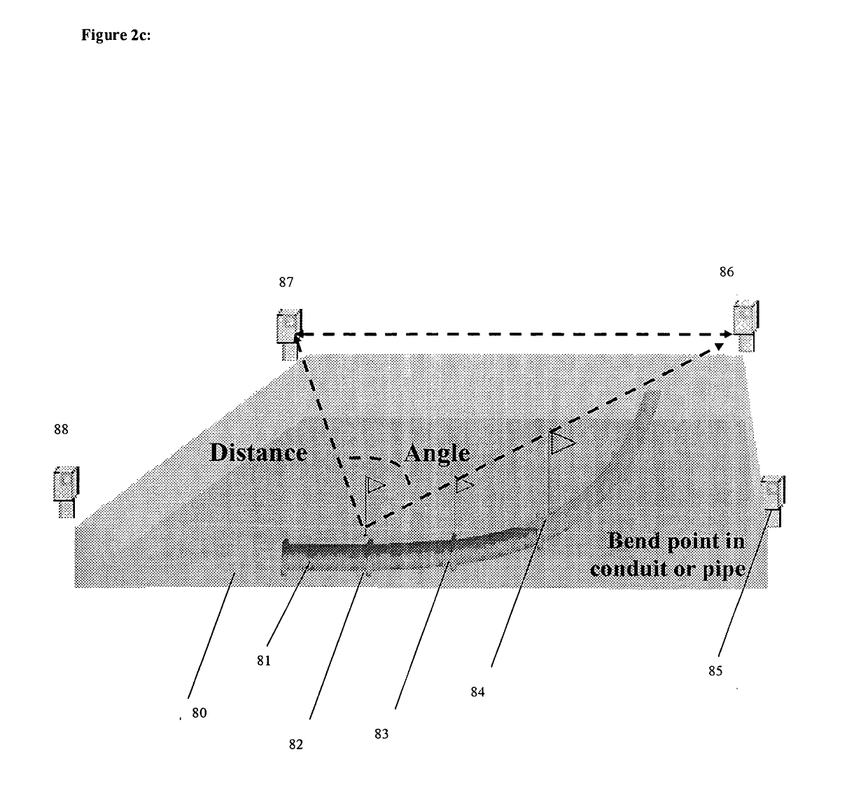

In the case of (D, A), the distance D is the distance of the Location Point from the reference point R1 (20 in FIG. 2) and the angle A is the angle between the line joining the reference point R1 to a second reference point R2 (21 in FIG. 2) and the reference point R1 to the location point (FIG. 2). The Depth at that Location Point typically may be locally relative (e.g., the depth of the Hidden Object below the ground surface if the object is underground or from a known local surface if the objects is concealed in a wall or other such structure) or locally absolute (e.g., a measurement with respect to some fixed point such as sea level). The Width refers to the width of the Hidden Object at that Location Point.

Similarly, an RFIDLI is also identified by Location Data, which includes similar attributes as required.

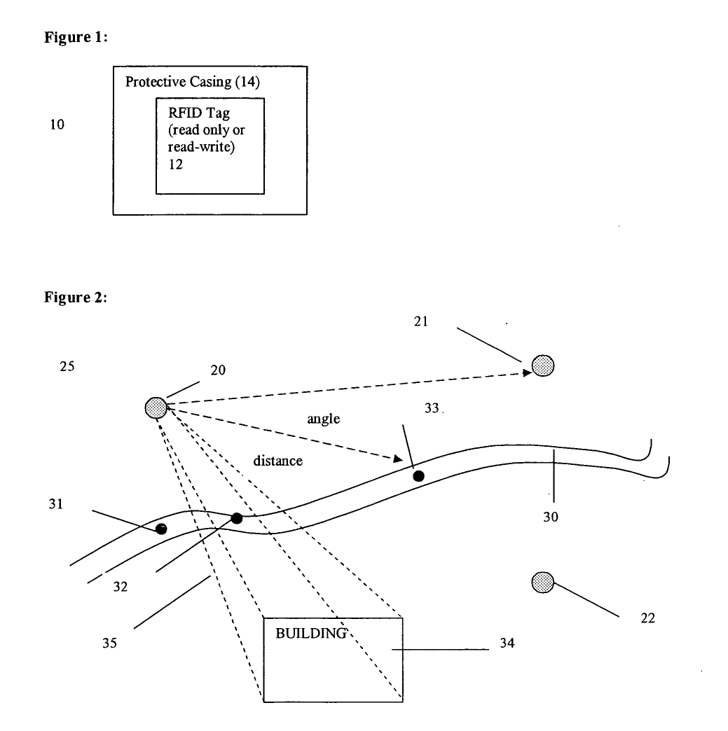

FIG. 1 is a diagrammatic view of an RFIDLI 10. The RFIDLI 10 includes an RFID tag 12 that is surrounded by an optional protective casing 14. The Protective Casing 14 is formed of a material that tends to prevent the tag from getting damaged or exposed to water or any harmful material. The protective casing 14 also prevents the tags from coming in direct contact with metal surfaces or structures. As will be appreciated, metal may impair the detection of RFID tags, depending on the radio frequency used. Those skilled in the art will be well familiar with RFID tags. The material and manufacture of the protective casing 14 will depend upon the specific application, and will be readily apparent to those skilled in the art depending thereon.

The RFID tag 12 may take any suitable form such as:

Passive read-only or read-write. Passive tags do not require any battery and are activated by the radio frequency signal from the RFID Readers.

Active read-only or read-write. Active tags are battery powered and therefore require replacing the battery when the battery runs out.

Semi-active/semi-passive read-only or read-write. Semi-active tags have a battery but the usage of the battery is optimized such that it is mostly in sleep mode and wakes up to power the chip only when an RFID Reader tries to read the tag or write into it.

Those skilled in the art will understand that active and semi-active/semi-passive tags have a much higher range than passive tags, and that the use of such technology depends upon application constraints.

A read-write tag typically contains a unique identifier and non-volatile memory that can be written to and read from by using an RFID Reader. Therefore, the tag can be programmed with the desired information as demanded by the needs of the specific application.

Read only tags can also be used to provide these solutions; in such implementations the unique identifier of the tag will be used to fetch the other information (that would be stored in non-volatile memory for a read-write tag) from storage on the Server.

All the references to RFIDLIs in the rest of this document assume the use of active read only tags. Depending on the requirements of the specific implementation, it may be necessary to use any of the other types of tags from those mentioned above.

The passive RFID tags can operate at different frequency ranges, one suitable frequency range being between 13.56 MHz and 2.45 GHz. Lower frequencies such as 13.56 MHz are better at penetrating dense medium and are not affected by metal or liquid based medium (the medium between the RFID tag and the Reader that reads the tag). However, 13.56 MHz technology may require the RFID Reader to have an antenna of several feet and also provides less range.

In contrast, higher frequencies allow the desired antenna geometry of the RFID Reader (in HDPU) to be smaller and therefore are more convenient to use. 915 MHz allows for a smaller antenna and offer a good compromise over the 2.45 GHz tags that have poor penetration characteristics. Thus 13.56 MHz or 915 MHz tags are well suited in many situations, depending on the penetration characteristics, range and the size of the antenna desired.

Some active tags use 868 Mhz or 916.5 Mhz as the operating or transmission frequency from the tag and 433 Mhz as the wake-up frequency. Those of skill in the art will be familiar that other frequencies that may also be used instead of these frequencies.

FIG. 2a pictorially illustrates five RFIDLIs 42, 43, 44, 45 and 46, in a certain physical area 40. There maybe more RFIDLIs in the area 40. Also shown is underground utility line 41. The RFIDLIs are placed directly above Location Points on utility line 41, on the surface above the ground. It is also possible to have the RFIDLIs placed underground, either attached to different points on utility line 41 or above it in the soil. FIG. 2b shows a sectional blown up view of the RFIDLI 42 of FIG. 2a.

To label utility line 41 using the RFIDLIs 42, 43, 44, 45 and 46, place these RFIDLIs at different locations directly above the utility line 41, on the surface. If 41 is an existing underground line, locate 41 using a map, metal detector or any other suitable mechanism and then place the RFIDLIs on it. If 41 is a new line, dispose the RFIDLIs as the line is put in place. Obtain the Location Data for the RFIDLIs using DGPS or any other suitable method, then collect this data along with the corresponding tag identifier of the RFIDLI in the Server database (the data is sent by HD to Server).

To track (or locate) the Hidden Object, use the HDPU's GPS to arrive at the approximate location of interest. Alternately, if the HDPU does not have GPS capability, use a map or any other suitable mechanism such as using a known landmark as reference to arrive at the approximate location of interest (Current Location). Next, provide the Current Location as input to the h-sw on the HD to obtain the Location Data of nearby RFIDLIs. The h-sw should preferably have a GUI interface to provide the information conveniently and allow the data to be managed as the RFIDLIs are located.

Continuing on with tracking, with this data use the RFID Reader to read, detect and then locate the RFIDLIs that are within the range of the Reader. Since active RFID tags can be detected from even 150 feet away and the range can be tuned or changed, progressively keep reducing the range to zoom into an RFIDLI. If using passive tags of about 10 ft range, visually locate the RFIDLI or Hidden Object once a reading is obtained. Once an RFIDLI is located, place a visual marker to label it. It is also possible to use a dual frequency RFIDLI where the RFIDLI includes an active tag (higher range) and a passive tag (typically 13.56 Mhz passive tag with a much lower range). In that case, the RFID Reader (s) would have the ability to read both the tags; first the active tag would be detected to find the vicinity of the dual frequency tag and then by zooming in once you are close to the tag use the lower frequency RFID Reader to read the passive tag (range <1 m) and locate it.

If an RFIDLI is lost, take two other RFIDLIs, consider one to be the Base and the other as the Reference. Now place a survey instrument on the Base and point to the Reference to obtain a reference reading. Then use the h-sw to obtain the angle of rotation from the Reference and the distance of the lost RFIDLI from the Base—provide these as input to the survey instrument to identify the location of the lost RFIDLI. If you repeat this using another set of RFIDLIs as Base and Reference RFIDLIs, you can reduce the margin of error due to the survey instrument and obtain an even more accurate reading.

Also, note that once you have detected a few RFIDLIs in a certain area, certain embodiments of the present invention enable you to use the Location Data of a known (or detected) RFIDLI as a reference point to obtain other RFIDLIs that are in its vicinity. This way, during tracking (or locating) of a Hidden Object the only time you need a GPS is at the start.

One can place RFIDLIs on valves, bends and other such points of interest and record the fact that the specific RFIDLI is on a valve (or bend etc.) in the Server database. This way, in addition to locating the underground asset from above the ground, you can also use the solution to locate valves, bends and more, easily and fast in the case of an emergency. Note, the valves can be above the ground.

With reference to FIG. 2, we now describe how RFIDLIs can be used to track and locate a Hidden Object where the RFIDLIs are near the asset but not on or directly above it. FIG. 2 pictorially illustrates three RFIDLIs 20, 21 and 22 that are placed at different locations in a certain physical area 25. The area 25 refers to land that may belong to the government, private individual owners or commercial area. Also shown in FIG. 2 are a utility line (Hidden Object) asset 30 disposed underground and a building 34 both found within the certain physical area 25. RFIDLIs 21, 21 and 22 may be above the ground or under the ground; these may be three of a plurality of additional RFIDLIs disposed within the certain physical area 25.

To label the asset 30, the Location Data Set of the asset 30 is obtained either from digitized maps or by collecting Differential GPS co-ordinates of different Location Points on asset 30 when it is installed. The Location Data Set of asset 30 is stored in the database on the Server. Next, when the RFIDLIs (20, 21 and 22) are placed at different locations in 25, the Differential GPS co-ordinates are obtained for each RFIDLI. The data is collected via the HD and transmitted wirelessly to the Server for storage in the database.

Alternately, instead of taking the Differential GPS readings for each of the Location Points on asset 30 or the RFIDLIs, it is also possible to get the Location Data for each of these Location Points on asset 30 and some of the RFIDLIs (Other RFIDLI) using one of the following:

Relative-label Method 1: In this case, use two known RFIDLIs (whose co-ordinates are known), one as the Base RFIDLI (20) and the other as the Reference RFIDLI (21). Place a survey instrument on the Base RFIDLI and focus it on the Reference RFIDLI to get a reference traverse. Next, rotate the survey instrument to focus on a Location Point on asset 30 or Other RFIDLI to obtain it's location relative to the Base RFIDLI as angle (A) and distance (D). The angle is the angle by which the survey instrument needs to be rotated from the reference traverse to the Location Point on asset 30 or Other RFIDLI; the distance is the distance between the Base RFIDLI and the Location Point on asset 30 or Other RFIDLI. This data is converted and stored on the Server as absolute GPS co-ordinate.

Relative-label Method 2: Use two known RFIDLIs (whose co-ordinates are known), one handheld laser and two prisms on bipods for this method. Place the bipods on the two known RFIDLIs (known co-ordinates), stand on the Location Point on the asset 30 or the Other RFIDLI (Label Location) whose co-ordinates are needed and shoot the laser back to the two prisms to obtain the distance to the two prisms. Using the Location Data of the two known RFIDLIs and the distances of the two RFIDLIs from the Label Location, the h-sw automatically calculates the Location Data of the Location Point on asset 30 or the Other RFIDLI.

To track (locate) the asset 30, first use the HD's GPS, a separate GPS device, a map or known landmark to arrive at the approximate location of interest. Then, input the current location into the h-sw of the HD to obtain the Location Data of nearby RFIDLIs (say 20 and 21). It is possible to channel the output of the GPS directly into the h-sw of the HD, to make it easy for the user to specify the current location.

Next, use the RFID Reader to locate two RFIDLIs, one is referred to as the Base RFIDLI (20) and the other as the Reference RFIDLI (21). Place a survey instrument on 20 and focus it on 21 to calibrate it. Next, based on the Base (20) and Reference (21) RFIDLIs, obtain Location Data of different Location Points 31, 32 and 33 on asset 30 as angles and distances(D, A). Angle A represents the angle by which the survey instrument needs to be rotated from the Reference (from the reference-line joining 20 and 21 to the line from the Base 20 to the LP 31, 32 or 33) and distance represents the distance D of the Location Point (31, 32 or 33) from the Base RFIDLI 20. This way the user may locate and mark each Location Point on asset 30. To minimize the survey instrument's error, this process may be repeated again using a different Base RFIDLI (21) and Reference RFIDLI (22).

In this method all Location Data for the RFIDLIs and the Location Data Set of the asset are stored as absolute co-ordinates. A user can arrive at a certain area, make one RFIDLI in that area as the Base RFIDLI and another as the Reference RFIDLI, and then follow the steps outlined above to locate the asset. It is also possible to store the Location Data of the asset and the RFIDLIs relative to a known reference point instead of as GPS co-ordinates.

Another technique can be used for locating underground lines. This technique uses a handheld laser and two prisms on bipods, in addition to the components outlined in FIG. 2. In FIG. 2c, asset 81 is an underground utility line in an open plot of land 80. Location Points 81-84 are on the asset 81 and RFIDLs 85-88 are placed in the vicinity of the asset 81.

After you locate two RFIDLIs (86 and 87) using the HDPU (as mentioned above for FIG. 2), place the bipods on the RFIDLIs 86 and 87 (whose co-ordinates are known). The person locating the buried line stands at a point in the vicinity of the 86 and 87 and shoots the laser back to the prisms to obtain the distance to the two prisms. A triangle is plotted on the HD (h-sw) showing the location of the person, the location of a point of interest (Location Point) on the line (the point one is trying to locate). The HD provides the distance and the direction the person should move to be located directly on the point. The person relocates and re-shoots the distances. Once a point is located on the line 82, adjacent points 83 and 84 along the trajectory are located similarly based on information provided through the HD.

There is another possible implementation for FIG. 2 where an RFIDLI is associated with a next and a previous RFIDLI as well as certain Location Points on the asset. In this case, corresponding to each RFIDLI (say 20), information that is stored (if using read only tags on the Server or, if using read-write tags, in the writeable area of the RFID tag) against the RFID tag identifier of the RFIDLI includes the following:

Type of object that is been identified (power line, waste water line etc.). The object here is the utility line asset 30.

Ownership and other related information regarding the Hidden Object.

The Location Data of the RFIDLI 20.

The Location Data for some of the Location Points in its vicinity say 31, 32 and 33; these are location points on the utility line asset 30.

The Location Data of the next RFIDLI 21. If this is the Last RFIDLI, it's next RFIDLI is NULL.

The Location Data of the previous RFIDLI (since this is the First RFIDLI, this would typically be NULL). First RFIDLI does not have a previous RFIDLI.

As mentioned earlier, the Location Data for each of the above bullets can be absolute or relative to a reference point (could be the RFIDLI itself). Of course, the above list of information is merely one possible set of information that may be stored in each RFIDLI.

In addition, other information such as when the RFIDLI was installed, a last time the RFIDL was read and other information may also be stored. In certain cases, information relating to curvature of utility line asset 30 may also be stored.

If using read-write RFID tags some or all of the information may be stored in the RFID tags. If using read-only RFID tags, typically the only information that will be present at 20 and 21 will be the unique RFID tag identifier. In this case, all other relevant information that is mentioned above will be stored and fetched as needed from the Server, or HD, or perhaps provided manually by the user. If using this method, the Location Data Set of asset 30 is obtained from digitized maps, by collecting Differential GPS co-ordinates of different Location Points on asset 30 when installed, or by using Relative-label Method 1 or Relative-label Method 2. The user would then store the Location Data Set in the database on the Server, and next, place RFIDLIs at different locations in 25 and obtain their DGPS co-ordinates. Following that, use tools provided by the h-sw or s-sw to associate each RFIDLI with its next and previous RFIDLI and a set of Location Points of asset 30. To locate, use a technique that is similar to the one outlined above (FIG. 2 tracking Hidden Object).

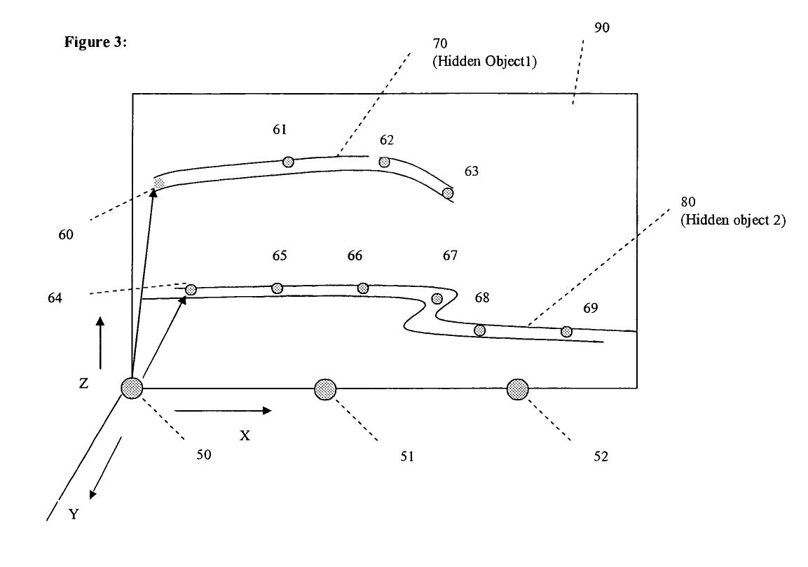

FIG. 3 illustrates a hidden object disposed in a structure and will be used to describe how the invention can be used to detect concealed objects in a wall or other non-horizontal structure. Often times, electrical, communication, plumbing, water, waste and other lines are present as concealed objects inside walls. Additionally there are other objects such as vertical beams (made of wood) that often need be detected externally for different purposes. This invention can be used to effectively detect all such concealed objects from outside, without damaging these objects by drilling.

FIG. 3 illustrates a vertical structure 90, like a wall, including concealed utility lines 70 and 80. Utility lines 70 and 80 represent, for example, concealed utility lines (Hidden Objects) within a vertical wall in a manufacturing facility, warehouse or other commercial or residential property. On or in the vicinity of the vertical structure 90 are disposed three RFIDLIs 50-52. There may be other such RFIDLIs disposed in the vicinity. Location Points 60-63 are disposed on utility line 70 and Location Points 64-69 are disposed on utility line 80. Two possible solutions are described below as solution 3A, where the Location Points are not RFIDLIs (or do not have RFIDLIs on them), and solution 3B where the Location Points are also RFIDLIs.

In the case of solution 3A, RFIDLI 50 is used as the Base RFIDLI and RFIDLI 51 is used as the Reference RFIDLI. The Location Data of all the Location Points on a utility line are calculated relative to the Base RFIDLI (x=0, y=0, z=0). Here x=0, y=0 and z=0 is used for simplicity. It is possible to have the Base at x=x1, y=y1 and z=z1, where x1, y1 and z1 may or may not be 0. The Location Data of RFIDLIs 51 and 52 are also calculated relative to RFIDLI 50. To determine the Location Data of the different location points on utility lines 70 and 80, one can use a simple tape or similar device to calculate the x, y and z co-ordinates of the Location Point from the Base RFIDLI 50. Alternately, you can use a survey instrument like Total Station or Laser and with RFIDLI 50 as the Base RFIDLI and RFIDLI 51 as the Reference RFIDLI.

Continuing on with the description of FIG. 3A, place the survey instrument on the Base, focus it on the Reference to calibrate and then rotate it from the Reference to focus on a Location Point 61. The survey instrument will tell you the angle of rotation and the distance from the base—(angle 1, distance 1 for the X-Y plane and angle2, distance2 for the X-Z plane); use these values to calculate the x, y and z co-ordinates of Location Point 61 relative to RFIDLI 50. Enter the data in the h-sw of the HD and transmit for storage on the Server. Also, store information corresponding to utility lines 70 and 80 like the name of the Hidden Object, its type (electrical line, water line etc.), ownership information, install date, maintenance history and more.

To locate a Hidden Object 70, e.g., first arrive at and read the RFIDLI 50 (Base) using the RFID Reader. The information on the location of the RFIDLIs is obtained from the HD (h-sw) which communicates wirelessly with the server to obtain such information. Instead of RFIDLI 50, any of the other RFIDLIs (51, 52 etc.) may also be used as Base. Next, make RFIDLI 51 the Reference RFIDLI. Place a survey instrument on the Base, focus it on RFIDLI 51 to calibrate it. Now, obtain the Location Data for different Location Points on the utility line 70 using the HD (h-sw) relative to the Base RFIDLI 50 and use the survey instrument to determine the locations of all the Location Points on utility line 70, as described previously for locating Hidden Objects in FIG. 2. You can use a survey instrument like Total Station or Laser. Alternately, it may be also possible to locate the Location Points on utility line 70 using a simple measuring tape once you obtain the Location Data of the different Location Points relative to the Base RFIDLI (no Reference RFIDLI needed in this case).

The other solution of FIG. 3, 3b, uses RFIDLI 50 as the Root Node RFIDLI while all the Location Points on the utility lines 70 and 80 are also RFIDLIs (60, 61, 62, . . . 69). While it is preferable to implement this solution by storing all the data corresponding to RFIDLI's tag identifier on the Server in the database, it is possible to implement this solution using read-write tags for simplicity. In this case, it is better to use an active tag for 50 and passive 13.56 MHz or 915 MHz tags for the RFIDLIs that are on the utility lines 70 or 80.

The Root Node RFIDLI contains the Location Data of itself and the Location Data of Location Points 60 and 64, the Starting RFIDLIs as co-ordinates relative to RFIDLI 50, for the utility lines 70 and 80 respectively. Location Points 60 and 64, the Starting RFIDLIs contain the Location Data of itself, the Location Data of the next RFIDLI (61 and 65 respectively) and the Location Data of its previous RFIDLI (NULL for Starting RFIDLIs). Similarly, all the other Location Points on utility lines 70 and 80 store information on their Location Data, the Location Data of the next RFIDLI and the Location Data of the previous RFIDLI.

To label the assets 70 and 80 using this method, first place the RFIDLI 50 and store Location Data on the Server. Next to label a utility line 70, place the Starting RFIDLI 60 on utility line 70. Store the Location Data of RFIDLI 50, the Location Data of Location Point 60 (and other Starting RFIDLIs) and other information on the writeable area of the RFIDLI 50. Alternately, if using read only tags store all the data corresponding to the tag identifier of RFIDLI 50 on the Server. Similarly, in RFIDLI 60 store the Location Data of itself and the location data of the next RFIDLI 61 (since this is the Starting RFIDLI, the previous RFIDLI=NULL). Use this method to store data corresponding to each of the RFIDLIs 62 and 63.

To locate a line 70 using solution 3B, first arrive at the vicinity of RFIDLI 50 and use the RFID Reader to read the tag and locate it. You will now have the Location Data for Location Point 60. You can use a simple tape to mark the Location Point 60 using the data and then read the RFIDLI using an RFID Reader to obtain the co-ordinates of the next Location Point 61. If you use read-write tags use the HD (h-sw) to view the tag data. Use this technique to read the other Location Points 61, 62 and 63. Alternatively, it is possible to use a survey instrument as well.

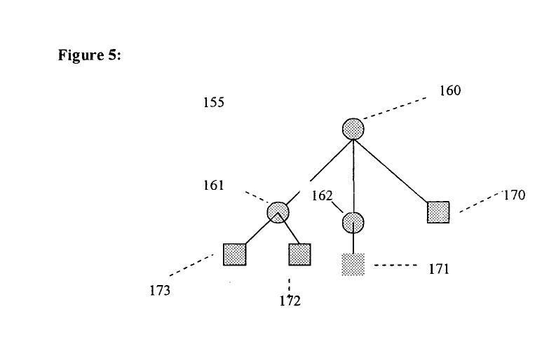

FIG. 3 represents a single wall or non-horizontal structure. Often, say in a commercial building or large manufacturing facility, you will have many walls and other structures with many Hidden Objects in each such structure. In addition, there will be underground Hidden Objects. FIG. 5 outlines how you can start with a Root Node RFIDLI and locate all Hidden Objects using a reference tree 155.

In a case where there are multiple hidden objects, start with the Root Node RFIDLI 160, read its Location Data to locate the Intermediate Node RFIDLIs 161 and 162 and the Starting RFIDLIs (170). The Intermediate RFIDLI 161 contains the information on the Starting RFIDLIs (172 and 173). It may also have information on other Intermediate Node RFIDLIs. Traverse down the tree to read the contents of the nodes to locate the Starting RFIDLIs, the starting point for each Hidden Object. Then use the mechanism described with reference to solution 3B above to locate the entire Hidden Object. If using solution 3A, instead of Starting RFIDLI the Root or an Intermediate RFIDLI will point to a Base RFIDLI which will have a Reference RFIDLI as the leaf node. The RFIDLIs mentioned in FIG. 5 can be implemented using either Read only tags or read-write tags.

For example, Root Node RFIDLI 160 may contain:

Unique RFID identifier

Company, ownership and other reference information as needed

The Location Data for itself (160)

Location Data for the Intermediate RFIDLIs and the Starting RFIDLIs (or Base RFIDLI) that form its immediate child nodes.

In FIGS. 5, 161 and 162 are Intermediate RFIDLIs while 170 represents a Starting RFIDLI. The Reference Tree 155 shown in FIG. 5 can be of any depth, depending on the complexity of the structure and the locations of the Hidden Objects.

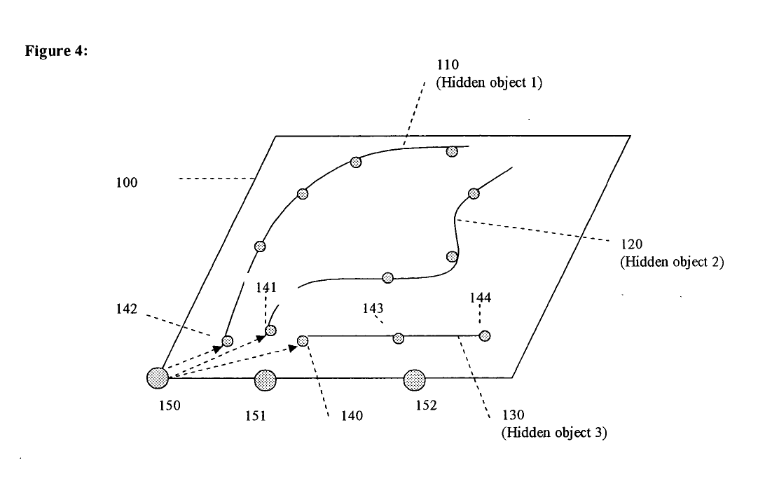

Similar to FIG. 3, FIG. 4 shows how objects that are underground and other areas where GPS does not work (e.g., inside a building) or is unavailable may be located. As in the case of FIG. 3, in this case also there are 2 possible solutions 4A and 4B which are similar to solutions 3A and 3B respectively. In the case of solution 4A, we use a Base RFIDLI and a Reference RFIDLI to locate different Location Points on the utility lines 110, 120 or asset 30. In FIGS. 4, 150, 151 and 152 are all RFIDLIs and any of these can be used as Base or Reference RFIDLIs. In the case of solution 4B, we use RFIDLI 150 as a Root Node RFIDLI and use it to locate the Starting RFIDLIs 140, 141 and 142. Next, use a method similar to solution 3B to locate the Location Points on the different utility lines. In this case, all the Location Points shown on the utility lines are also RFIDLIs.

FIG. 6 shows a system 200 in accordance with one embodiment of the present invention. The system 200 includes an RFIDLI 160, two Handheld Data Processing Units (HDPUs) 180 and 240, and a Server 200. A HDPU unit as mentioned earlier typically includes a Handheld RFID Reader and a handheld device (HD) such as a PocketPC or PDA. The Handheld RFID Reader reads from (and if read-write tag writes into) the RFID tag in an RFIDLI. The RFIDLI may be active or passive, depending on the range and other requirements.

The HD is a PocketPC, PDA, smart wireless phone, or such, which runs the handheld software h-sw (as mentioned earlier). The RFID Reader of the HDPU communicates with the HD over a wireless connection like Bluetooth or a wired connection to send and receive data. The HD also communicates with the Server 200 (running the Server software) and other handheld devices running the h-sw or other software that is compliant with h-sw.

The communication between a HD and the Server is done over wireless (GPRS or other) technologies or by synchronizing the HD with a PC (which could be the Server) from where data is loaded to the Server. The communication between two HDs is done over wireless. The communication protocol used between the h-sw and the Server software or other Handheld software is HTTP, TCPIP, UDP, SMTP, SOAP or other connection oriented or connectionless protocols. This is marked as 190 in FIG. 6. The data exchange can occur using a secure line using encryption and authentication or without such security.

The HDPU may take any suitable form as will be appreciated by those of skill in the art. For example, the HDPU may have one or more Handheld RFID Readers (multiple readers to support different frequencies) and an HD, or may be a combined hybrid handheld device that includes RFID Reader (of one or more frequencies), microprocessor and memory to run our handheld software, wireless and/or wired communication capabilities, a screen to display data, the ability to input data and more. The HDPU may also have the ability to identify a location based on co-ordinates (GPS or relative, or both).

As shown in FIG. 6, the HDPU 180 communicates with the RFIDLIs. The RFID Reader of the HDPU reads data from an RFIDLI and sends it to the h-sw (handheld software) running on the HD. The h-sw logs the data in local storage, if storage is available. The HD then sends data to the Server or to one or more other handheld devices running suitable software. If there is no wireless connectivity for the HD to send data to the Server immediately, or if the system is arranged for offline synchronization, the data is stored locally in the HD and later uploaded to the Server or another PC (from where it is moved to the Server). The decision to send the data to the Server or other Handheld may be configurable.

Additionally, the h-sw can perform at least some of the following:

It has a graphical interface to allow the user to enter data and also view data and reports on the screen.

It communicates with the Server software and/or the handheld software in other HDPU devices to obtain other Location Data and other related data.

It respects the security protocols of different levels for RFIDL1s (important in defense applications and private applications, where not all information about mission critical utilities and objects should be available to everyone).

It can print the reports using a printer or download the data to a PC.

It has instant messaging and email capabilities to allow the user of the HDPU to communicate and collaborate with others instantly.

It also communicates with the RFID Reader to provide it with the data that needs to be written into the non-volatile memory of an RFID tag in An RFIDLI. The write data is obtained from one of the following sources:
The Server software
An input file
Or via a GUI Interface that allows the user to input the data manually.

The Server software (s-sw) runs on the Server hardware 200 of FIG. 6. The Server 200 receives the data (RFIDLI Content) read from the RFIDLIs by one or more HDPU units over a secure or non-secure channel as mentioned above. On receiving the RFIDLI Content, the s-sw's Data Management layer stores the data in the database (Server Database). In addition to this, the Data Management layer can read data from diverse data sources including files, databases and applications in real-time or batch mode. All received data is stored in the database (Database) or subsets of it can be channeled to other applications for further processing.

The data from the Database is then processed using business rules to generate reports and provide business intelligence via the Web and wireless devices (210). The Server also sends out email notifications (220) based on business rules. The Server software also includes technology to allow business or non-technical users to specify the presentation of the information so the data is presented via the Web and wireless using the presentation layout specified. This increases the effectiveness of the information.

As shown at asset 30, data from the Server can be channeled to other external applications that are used to plot maps, ensure compliance with different regulations, inventory management, financial applications and more. The Server communicates with these applications using Web services, the APIs of the applications or specific tools and methods defined by the applications to allow the importing of data into the applications.

The RFIDLI Content stored on the Server 200 in the database can be used to generate maps and other drawings showing the locations of the Hidden Objects in an area. In addition the data can be directly channeled to other applications to generate reports needed for compliance and other related processes.

When implemented for a User Company (see definition above), the Server Database over time will include the Location Data Set for all their Hidden Objects that are associated with the RFIDLIs such that they can be used to locate a Hidden Object easily anytime. This data is referred to as the Company Location Database. When the solution is implemented for a User Company, the entire solution may be offered as a complete solution that includes maintaining, hosting and operating the Server and all other components of the invention.

This invention also teaches the creation, compilation and maintenance of a master database of the Location Data Sets of the Hidden Objects along with the Location Data of the RFIDLIs belonging to some or all the User Companies that use this invention. This database is referred to as the Master Location Database and can be maintained as an ongoing service. This database will be highly secure and different views or snapshots of this information will be made available via the Web dashboards, wireless dashboards, files, database views or printed reports. The data may also be made available to other applications via Web services or other programming interfaces for a fee.

The RFIDLIs, whether they are placed on the Hidden Object or in the vicinity, can be smart labels effectively used for repair and maintenance purposes. For example, when the maintenance staff goes to the field to perform maintenance work, they can be equipped with an RFID enabled badge to uniquely identify the staff. Next, when they perform repair or maintenance on the Hidden Object, information on the make, model, maintenance and repair history and more can be obtained via the HD in real-time using one or more RFIDLIs as reference points.

Also, the maintenance or repair records for the work done at a particular location or section of the Hidden Object can be easily recorded (using the RFIDLIs as reference points) and sent to the Server Database for storage. The RFIDLI on or near the repair/maintenance location is read along with the RFID enabled badge of the staff. This allows easy retrieval of the records for that section of the Hidden Object and makes it easy to enter the current record via the HD. All the staff has to do is enter the description of the actual work performed; other data entry is minimized by reading the RFIDLI and the RFID enabled badge of the staff.

The RFIDLIs, if they are on the asset or near it, can also be used to actively monitor the asset in real-time at different Location Points to determine its health and send out alerts if anything in case of an abnormality.

Certain embodiments of the present invention will utilize common security techniques applied to certain aspect of the present invention that will be readily understood by those skilled in the art. According to these embodiments, the data stored in the non-volatile memory of the RFIDLIs (if using read-write tags) may be encrypted to provide security such that only those with authorization and the appropriate HDPUs can use the invention to detect the location of the Hidden Objects. Without the proper access privileges, if an RFID tag of any RFIDLI (Root Node RFIDLI, Intermediate Node RFIDLI, Starting RFIDLI or any other RFIDLI) is read using an RFID Reader, the contents of the RFID tag will be undecipherable.

In other secure embodiments, even if a user has the authorization to read one or more RFIDLIs, the user will be able to locate and obtain information on only those Hidden Objects for which the user has access privileges. Access privileges will also determine which user can write what information into the RFIDLIs. The entire security management including encryption, key management, authentication and access control is a part of the solution.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

I claim:

1. An RFID based location identifier (RFIDLI) for managing Hidden Objects, the RFIDLI comprising:
an RFID tag, said RFID tag including a tag identifier (tagId) that is used as a reference for storing Location Data of said RFIDLI; and
a protective enclosure surrounding said RFID tag, said protective enclosure suitable to protect said RFID.

2. An RFIDLI as recited in claim 1, wherein said protective enclosure is resistant to liquids.

3. An RFIDLI as recited in claim 1, wherein said RFID tag is a passive RFID tag.

4. An RFIDLI as recited in claim 1 wherein said RFID tag is an active RFID tag.

5. An RFIDLI as recited in claim 1 wherein said RFID tag is a semi-active RFID tag.

6. An RFIDLI as recited in claim 1, wherein said RFID tag is a read-only RFID tag.

7. An RFIDLI as recited in claim 1, wherein said RFID tag is a read-write RFID tag.

8. An RFIDLI as recited in claim 1, wherein said RFID tag is a first RFID tag and said RFIDLI further comprises a second RFID tag, wherein said first and second RFID tags have different read ranges.

9. An RFIDLI as recited in claim 1, wherein said RFIDLI is placed in the vicinity of the Hidden Object.

10. An RFIDLI as recited in claim 1, wherein said RFIDLI is placed directly on the Hidden Object.

11. An RFIDLI as recited in claim 1 wherein data stored in said RFID tag is encrypted.

12. An RFIDLI as recited in claim 1, wherein said RFID tag includes ownership information related to the Hidden Object or said identifier is used as a reference to store ownership information in the database on a remote device.

13. An RFIDLI as recited in claim 1, wherein said RFID tag further includes Location Data for other RFIDLIs or said identifier is used as a reference to store Location Data for other RFIDLIs in the database on a remote device.

14. An RFIDLI as recited in claim 13, wherein said RFID tag includes Location Data Set related to said Hidden Object or the RFID tag identifier is used as a reference to store such information in the database on a remote device.

15. An RFIDLI as recited in claim 1, wherein said RFID tag includes information related to a plurality of hidden objects or the RFID tag identifier is used as a reference to store such information in the database on a remote device.

16. An RFIDLI as recited in claim 1, wherein at least some data stored in said RFID tag is encrypted.

17. A handheld data processing unit (HDPU) for use in managing hidden objects, said HDPU used in conjunction with at least one radio frequency identification based location identifier (RFIDLI) associated with at least one hidden object, said HDPU comprising:
an RFID reader operable to locate and read data from said at least one RFIDLI;
a handheld device (HD) coupled to and controlling said RFID reader in order to read data retrieved from said RFIDLI;
a communications device operable to communicate with a Server computer; and
software executing on said HD to store said data retrieved from said RFIDLI and forward to the Server computer.

18. A server suitable for use in tracking and managing a plurality of Hidden Objects that have been associated with a plurality of RFIDLIs, said server comprising:
a database storing information related to said plurality of Hidden Objects, said information related to said plurality of Hidden Objects including at least location information related to said plurality of Hidden Objects;
a communication device operable to communicate with one or more handheld data processing units (HDPUs) utilized on location of said plurality of Hidden Objects; and
software operable to access and provide data to said HDPUs through said communication device, as well as retrieve data from said HDPUs.

19. A server as recited in claim 18 further comprising business intelligence software executing on said Server operable to utilize said database and data retrieved from said HDPUs.

20. A system for tracking and managing a plurality of objects at least some of which are hidden, said system comprising:
a plurality of RFIDLIs, wherein each RFIDLI is associated with at least one of said plurality of objects, each of said plurality of RFIDLIs including:
an RFID tag, said RFID tag that has a unique tagId that is used to store and retrieve Location Data for one or more Hidden Objects; and
a protective enclosure surrounding said RFID tag, said protective enclosure suitable to protect said RFID tag;
a handheld data processing unit (HDPU) including an RFID reader operable to locate and read data from said plurality of RFIDLIs;
a HD (handheld device) coupled to and communicating with said RFID reader in order to read data retrieved from said RFIDLI; and
software executing on said HD for storing data obtained from the RFID Reader or a server locally and also to send data to the RFID Reader and said server as needed; and
said server including:
a database storing data related to said plurality of Hidden Objects;
a communication device operable to communicate with said HDPU utilized on location of said plurality of Hidden Objects;
software operable to access and provide data to said HDPU through said communication device, as well as retrieve data from said HDPUs; and
business intelligence software executing on said server operable to utilize said database and data retrieved from said HDPU.

21. A method for managing a Hidden Object comprising:
providing a plurality of RFIDLIs attached to or in the vicinity of said Hidden Object;
storing information against a tagId for each RFID tag including Location Data of Location Points related to said Hidden Object, Location Data of the RFIDLI itself, and Location Data of other RFIDLIs;
reading said information using HDPU on said RFIDLI; and
utilizing said information to locate the Hidden Object.

22. A method for managing a Hidden Object as recited in claim 21, wherein at least some of said information associated with said plurality of tagIDs is stored on a Server remote from said Hidden Object.

23. A method for managing a Hidden Object as recited in claim 21, wherein at least some of said information associated with said plurality of tagIDs is stored on each RFID tag.

24. A method for managing a Hidden Object wherein the act of utilizing said information to locate the Hidden Object includes:
moving to an approximate location of a Hidden Object;
obtain location data of one or more proximate RFIDLIs given a current location;
locate and read some or all RFIDLs that are in range;
place visual markers on all located RFIDLs. If the RFIDLIs are located directly above the Hidden Object on the surface, these are also the location points on the Hidden Object
if RFIDLIs are in the vicinity of the Hidden Object but not always directly above it on the surface or on it,
obtain the location data of multiple location points on the Hidden Object
use two or more RFIDLIs and measuring instruments (survey instrument or other) to locate the location points on the Hidden Object.

25. A method of managing a Hidden Object as recited in claim 24, where to locate points on the Hidden Object using two or more RFIDLIs, a handheld laser and two prisms on bipods,
place the bipods on two of the located RFIDLIs;
move to the vicinity of the Hidden Object to a location called current location;
shoot the laser back to the prisms to obtain the distance to the two prisms from the current location;
obtain and view information using the HD on the relative position of current location to different points on the Hidden Object;
move to a location on the HD using the information and re-shoot the laser back to the prisms. Repeat to obtain the exact location of a point on the Hidden Object and use this process to locate different location points on the Hidden Object.

26. A method for managing a plurality of Hidden Objects comprising:
utilizing a plurality RFIDLIs associated with said plurality of Hidden Objects as smart labels to easily collect maintenance history, make and other information about said Hidden Objects, wherein said maintenance history is retrieved using a Handheld Device HD to enable smart decision making during maintenance;
sending maintenance history and other information related to said plurality of Hidden Objects to a Server.

27. A method for monetizing a hidden object database comprising:
maintaining a database of information regarding a plurality of Hidden Objects;
providing remote access to said database of information regarding a plurality of Hidden Objects according to a subscription basis; and
coupling said database to remote users based on said subscription basis, enabling said remote users to take action accordingly in light of the presence and nature of Hidden Object found in the vicinity of said remote users.
